(19) United States
(12) Patent Application Publication
(10) Pub. No.: US 2006/0037247 A1
(43) Pub. Date: Feb. 23, 2006

(54) Window lifter rail

(76) Inventors: Thomas Heyer, Sassenburg (DE); Markus Waroch, Isenbuettel (DE)

Correspondence Address: CARLSON, GASKEY & OLDS, P.C., 400 WEST MAPLE ROAD, SUITE 350, BIRMINGHAM, MI, 48009, US

(21) Appl. No.: 11/199,805

(22) Filed: Aug. 9, 2005

(30) Foreign Application Priority Data
Aug. 17, 2004 (DE) 10 2004 039 851.8

(51) Int. Cl. E05F 11/48

(52) U.S. Cl. 49/352

(57) ABSTRACT

A window lifter rail includes a pulley and a pulley cover. The pulley cover can be fastened to the window lifter rail in various positions. This ensures an assembly unit that offers a more flexible use while also reducing the production and installation costs.

### BACKGROUND OF THE INVENTION

The application claims priority to German Application No. 10 2004 039 851.8, which was filed on Aug. 17, 2004.

The invention relates to a window lifter rail comprising a pulley and a pulley cover.

Window lifter rails with pulleys are used in cable pull type window lifters that lift and lower vehicle window panes. One known cable pull type window lifter includes a tensile member that is wound around a cable drum and several pulleys. In this arrangement, the pulleys are arranged on a window lifter rail, and the tensile member is connected to a driving dog. When the cable drum rotates, the driving dog is lifted and lowered and the window pane is moved to a desired position.

Traditionally, window lifter rails include a rigid abutment that deflects the tensile member at an angle in a region of the pulleys. Different angles require different rigid abutments, such that each complete assembly unit for a respective operating condition has a unique rigid abutment. This results in significantly increased costs, because a required deflection angle of the tensile member for force transmission varies according to vehicle type, and can vary within one vehicle type depending on window type.

It is the objective of the invention to provide an assembly unit for application in window lifters that offers a more flexible use in order to reduce the amount of work involved during production and to reduce costs.

### SUMMARY OF THE INVENTION

The subject invention provides a window lifter rail with a pulley and a pulley cover wherein the pulley cover can be fastened to the window lifter rail in various positions. The advantages achieved with the invention are in particular that the window lifter rail can be flexibly adapted to respective operating conditions. One important advantage is that the pulley and the pulley cover can be adapted to a specific vehicle type only on site, the production of these components is not dependent on the vehicle type and may be automated. This results in a decrease in production costs.

A compact assembly unit is made available in one embodiment, in which the window lifter rail is formed in one piece and the pulley and the pulley cover are directly fastened to the window lifter rail.

It is preferred that a fastening plate is mounted to the window lifter rail, the pulley and the pulley cover being fastened to this fastening plate. This is why a pre-assembly of the pulley and the pulley cover on the fastening plate is made possible, and the pre-assembled unit can be fastened to a vehicle at a later point in time.

Further, the pulley cover is preferably fastened or pre-fixed with hooks. Such hooks are commonly known as effective fastening elements that ensure a quick and reliable locking in place in the window lifter rail, and at the same time may be released quickly. Moreover, the production costs of such connections are low.

It is preferred that for a tensile member, such as a Bowden cable for example, a required abutment for sheathing is immediately integrated in the pulley cover, whereby it is possible to ensure that the tensile member remains in associated grooves of the pulleys, in particular during installation on the vehicle. A slot provided in the abutment receives the tensile member.

These and other features of the present invention can be best understood from the following specification and drawings, the following of which is a brief description.

### BRIEF DESCRIPTION OF THE DRAWINGS

FIG. 1 shows a schematic illustration of a cable pull type window lifter according to prior art.

FIG. 2 is a perspective partial view of a front of a window lifter rail according to the present invention.

FIG. 3 is a partial view of a rear of the window lifter rail according to the present invention.

### DETAILED DESCRIPTION OF THE PREFERRED EMBODIMENT

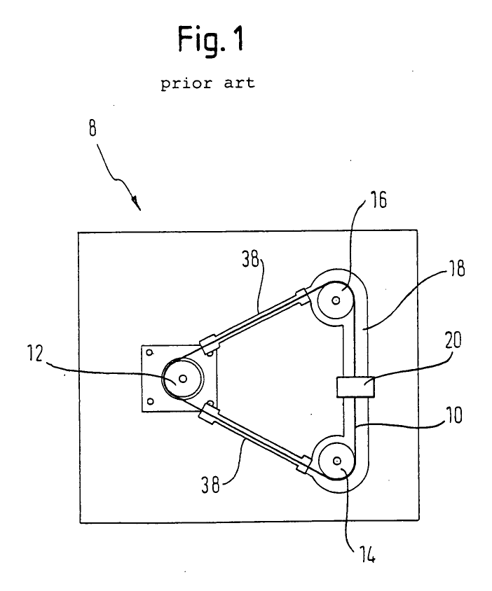

FIG. 1 schematically shows a traditional structure of a cable pull type window lifter 8. A tensile member 10 is wound around a cable drum 12 and is coupled by the cable drum 12 to a cable drive (not shown). The tensile member 10 is guided in a closed loop over a lower pulley 14 and an upper pulley 16. The lower and upper pulleys 14, 16 are fastened to a window lifter rail 18, and the tensile member 10 is provided with a sheathing at intermediate sections 38 between the lower and upper pulleys 14, 16 and the cable drum 12, if necessary. A driving dog 20 is connected with the tensile member 10 and with a window pane (not shown), so that the window pane can be moved upwards or downwards to a desired position by rotating the cable drum 12. The exact function of a cable pull type window lifter 8 will not be discussed here, since it is known from prior art and the invention related to deflection of the tensile member 10 in a region of the lower and upper pulleys 14, 16.

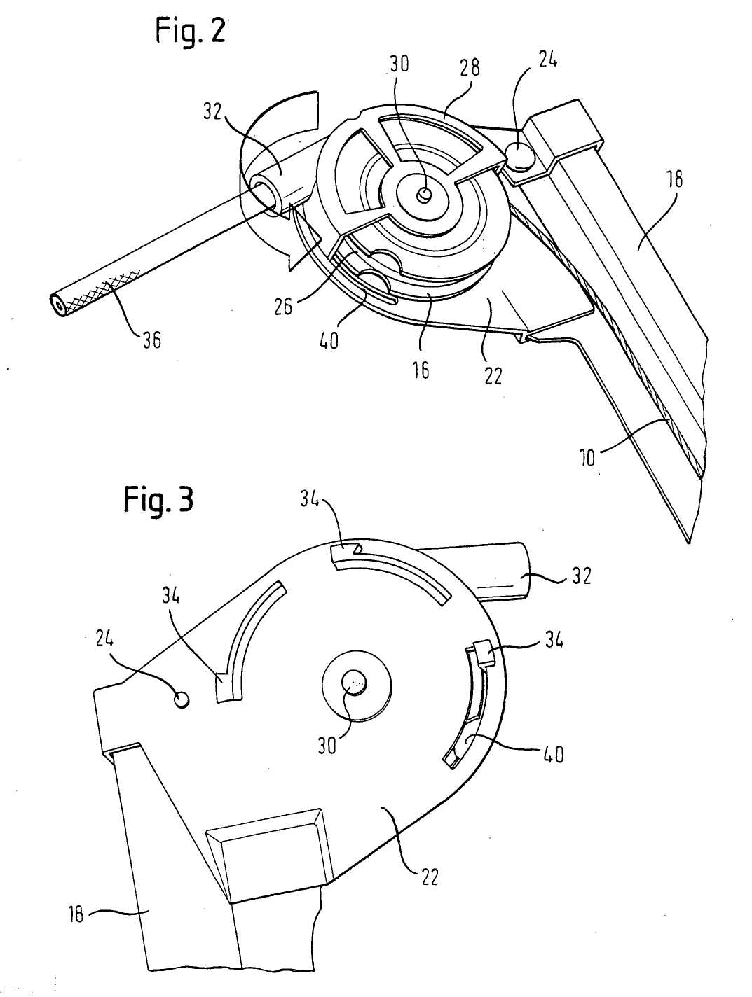

FIG. 2 shows a part of the window lifter rail 18 with the upper pulley 16 in a configuration incorporating the subject invention. The lower pulley 14 has a similar design.

A fastening plate 22 is mounted to the window lifter rail 18. The window lifter rail 18 is inserted in a pocket on the fastening plate 22 and is connected with the fastening plate 22 by a connecting element 24, which is preferably a rivet or screw.

The upper pulley 16 has a peripheral groove 26 adapted to guide the tensile member 10. A pulley cover 28 is arranged over the upper pulley 16 and partially covers the upper pulley 16. The upper pulley 16 and the pulley cover 28 are commonly fastened to the fastening plate 22 by a second connecting element 30 such as a screw or rivet. The upper pulley 16 is rotatably supported and the pulley cover 28 is immovably mounted to the fastening plate 22 by hooks 34 (FIG. 3).

The pulley cover 28 has an abutment 32 on one of its ends. The tensile member 10 has a sheathing 36 at the intermediate sections 38 (FIG. 1) of the tensile member 10. Ends of the sheathing 36 rest against the abutment 32, because the tensile member 10 preferably is realized as a Bowden cable. As the use of a Bowden cable is known in this field, this will not be explained in further detail here.

The tensile member 10 is guided generally in parallelism to the window lifter rail 18 and in the peripheral groove 26 of the upper pulley 16. At the abutment 32, the tensile member 10 leaves the upper pulley 16 and the pulley cover 28 in the desired direction.

Upon actuation of the cable drive (not shown) the tensile member 10 is moved in a clockwise or counter clockwise direction, depending on the direction of movement of the window pane (not shown). In this process, friction of the tensile member 10 on the upper pulley 16 may virtually be neglected, because the upper pulley 16 is rotatably supported.

FIG. 3 shows a rear of the window lifter rail 18. The pulley cover 28 is fastened to the fastening plate 22 by hooks 34. These hooks 34 engage in annular cut-outs 40 that are arranged in sections on the fastening plate 22.

The pulley cover 28 is assembled in the following manner. At first, the pulley cover 28 is pre-assembled on the fastening plate 22 by the hooks 34. In so doing, the pulley cover 28 can be arranged in various positions (see the arrow in FIG. 2) without requiring a tool. If the pulley cover 28 is arranged with the desired angle, the pulley cover 28 is fastened in the respective position with the second connecting element 30. In this way the desired deflection angle of the tensile member 10 (in this embodiment between 45° and 90°) can be adjusted. This is why the deflection angles, which vary depending on the vehicle type, can be altered without newly producing the individual components of the window lifter rail in an expensive way.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A window lifter rail assembly comprising:
a pulley; and
a pulley cover wherein the pulley cover can be fastened to a window lifter rail in various positions.

2. The window lifter rail assembly according to claim 1 wherein the window lifter rail is formed in one piece and serves as a fastening plate for the pulley and the pulley cover.

3. The window lifter rail assembly according to claim 1 including a fastening plate mounted to the window lifter rail wherein the pulley and the pulley cover are fastened to the fastening plate.

4. The window lifter rail assembly according to claim 1 wherein the pulley cover is fastened with hooks.

5. The window lifter rail assembly according to claim 1 wherein the pulley is rotatably supported.

6. The window lifter rail assembly according to claim 1 wherein the pulley cover comprises an abutment against which a sheathing of a tensile member rests.

7. The window lifter rail assembly according to claim 1 including a tensile member supported by the pulley wherein the pulley cover is fastened to the window lifter rail in at least one of the various positions to achieve a desired deflection angle of the tensile member.

8. A method of assembling a window lifter rail assembly comprising the steps of:
a) mounting a pulley and a pulley cover to a fastening plate to form a sub-assembly; and
b) mounting the sub-assembly to a window lifter rail in one of a plurality of different positions.

9. The method according to claim 8 including fastening the pulley cover to the fastening plate with a plurality of hooks.

10. The method according to claim 8 including rotatably supporting the pulley.

11. The method according to claim 8 including supporting a tensile member on the pulley and fastening the pulley cover to the window lifter rail in one of the plurality different positions to achieve a desired deflection angle of the tensile member.
